(19) United States
(12) Patent Application Publication
(10) Pub. No.: US 2019/0127555 A1
(43) Pub. Date: May 2, 2019

(54) METHOD TO IMPROVE THE SURFACE MODIFICATION BY USING ALKYLBORANES

(71) Applicant: BASF SE, Ludwigshafen am Rhein (DE)

(72) Inventors: Rainer KLOPSCH, Ludwigshafen (DE); Klaus BREUER, Ludwigshafen (DE); Xiao FU, Singapore (SG); ChangE Angeline TAN, Singapore (SG); Marc Rudolf JUNG, Ludwigshafen (DE)

(73) Assignee: BASF SE, Ludwigshafen am Rhein (DE)

(21) Appl. No.: 16/306,301

(22) PCT Filed: May 23, 2017
(86) PCT No.: PCT/EP2017/062431

§ 371 Date: Nov. 30, 2018

(30) Foreign Application Priority Data
Jun. 1, 2016 (EP) 16172438.0

(51) Int. Cl. C08K 5/55; C08J 7/16

(52) U.S. Cl. CPC C08K 5/55; C08J 7/16; C08J 2471/02; C08J 2439/06; C08J 2323/12

(57) ABSTRACT

Process for the modification of a surface of a solid substrate comprising treatment of the surface with (i) a solution comprising an organoborane-amine complex and a polymer and subsequently with (ii) a polymerizable compound (herein referred to as “monomer”) and optionally a deblocking agent

The invention relates to a process for the modification of a surface of a solid substrate comprising treatment of the surface with
(i) a solution comprising an organoborane-amine complex and a polymer and subsequently with
(ii) a polymerizable compound (herein referred to as “monomer”) and optionally a deblocking agent.

Organoborane-amine complexes are known as initiators of radical polymerization. For example in U.S. Pat. No. 6,248,846 polymerizable acrylic compositions are described that comprise an organoborane-amine complex. The mixture further comprises an acid to liberate the organoborane and initiate polymerization.

WO 2010/149637 discloses coating compositions comprising a radical curable compound, an organoborane-amine complex and carbonic acid as deblocking agent. The carbonic acid is produced in situ by reacting carbon dioxide with water.

A two step process for chemical modification of low energy polymer surfaces is known from WO 2013/156892. In a first step the surface is treated with a solution of the organoborane-amine complex. In a second step the surface is treated with a radically polymerizable monomer and a deblocking agent.

Modifications of low energy surfaces include, for example, technical processes like coating or printing on low energy surfaces or antibacterial modification of low energy surfaces, in particular on polypropylene. For such technical processes a good and uniform coverage of the surface as well as a good adhesion to the surface are required. In this regard, the process according to WO 2013/156892 still requires further improvements.

Hence it was an objective of the present invention to provide an improved process for the modification of polymer surfaces.

Accordingly, the above process has been developed.

To the surface of the solid substrate

The solid substrate may be any kind of body and may have any form, for example, the solid substrate may be a film, sheet or board. Preferably, the surface of the solid substrate is a polymer surface. The word polymer does include also a blend of polymers.

The polymer surface may be made of any polymer. In particular, the polymer of the polymer surface is a polymer with a low surface energy.

A polymer with a low surface energy usually shows only poor interaction with liquids and a low wettability. Low surface energy polymers are usually characterized by their contact angle, i.e. the angle at which the liquid-vapor interface of a droplet meets the solid-liquid interface. A large contact angle generally means that wetting of the surface is unfavorable so that the liquid will minimize contact with the surface and form a compact droplet. In this invention a low-energy polymer surface has a contact angle in the range of from 90° to 180°, preferably in the range of from 95° to 150°, more preferably in the range of from 95° to 135°.

Examples of polymers with low surface energy are polydimethylsiloxane (PDMS), polyethylene (PE), polypropylene (PP), polytetrafluorethylene (PTFE) and polystyrene (PS).

Hence, surfaces of PDMS, PE, PP, PTFE and PS or of any blend thereof or any blend comprising the fore-standing polymers in an total amount of at least 50%, in particular of at least 70%, most preferred of at least 90% by weight are preferred polymer surfaces.

Particularly preferred are surfaces of PDMS, PE, PP, PTFE and PS. Most preferred is PP.

In a most preferred embodiment the whole substrate is a polymer substrate, like a polymer film, a polymer sheet or polymer board. In such preferred embodiment the whole substrate is of the same polymer as is its surface and the above embodiments regarding the polymer of the polymer surface apply to the polymer of the whole substrate as well.

To step (i)

According to the invention the process comprises treatment of the surface of a solid substrate with a solution comprising an organoborane-amine complex and a polymer.

The organoborane-amine complex may be a single organoborane-amine complex or a mixture of different organoborane-amine complexes.

Preferably, the organoborane-amine complex has a structure of formula (I)

R₁R₂R₃B—NR₄R₅R₆ (I),

wherein R₁, R₂ and R₃ are independently alkyl, cycloalkyl or their heteroatom substituted derivatives, alkylamino, aryl, heteroaryl, alkoxy or aryloxy groups, with the proviso that at least one of R₁, R₂ and R₃ is an alkyl or aryl group, and
R₄, R₅ and R₆ are independently hydrogen, alkyl, cycloalkyl, substituted alkyl, alkoxy, alkylamino, aryl or heteroaryl groups, with the proviso that not more than two of R₄, R₅ and R₆ are simultaneously hydrogen, or NR₄R₅R₆ is a heterocyclic aliphatic or aromatic amine, optionally comprising further at least one heteroatom selected from the group, consisting of N, O, S and P.

In a preferred embodiment of the present invention the organoborane-amine complexes are trialkylborane-amine complexes, with R₁, R₂ and R₃ being alkyl groups. The alkyl groups may be identical or different. Even more preferred R₁, R₂ and R₃ are independently selected from the group, consisting of methyl, ethyl, propyl, isopropyl, butyl, isobutyl and sec-butyl. Most preferred R₁, R₂ and R₃ are identical.

The amine NR₄R₅R₆ in the organoborane-amine complexes is a compound with at least one primary, secondary or tertiary amino group or a ring system comprising at least one nitrogen atom. Such ring system may be a heterocyclic aliphatic or an aromatic ring system, that may contain further heteroatoms selected from the group, consisting of O, S and P.

Preferred are primary and secondary amines, even more preferred are primary amines. In one embodiment of the present invention the organoborane-amine complexes comprise an amine NR₄R₅R₆, which is a heterocyclic aliphatic or aromatic amine, that may contain further heteroatoms selected from the group, consisting of N, O, S and P.

In another preferred embodiment of the present invention the organoborane-amine complexes comprise an amine NR₄R₅R₆, which is selected from the group, consisting of 1,2-diaminopropane, 3-methoxypropylamine, 4-dimehtylaminopyridine, 1,4-diazabicylco[2.2.2]octane, diethylenetriamine, triethylenetetraamine, propylamine, morpholine and piperidine.

As used in connection with the present invention, the term “alkyl” denotes a branched or an unbranched saturated hydrocarbon group comprising between 1 and 24 carbon atoms; examples are methyl, ethyl, propyl, isopropyl, butyl, isobutyl, sec-butyl, tert-butyl, amyl, isoamyl, sec-amyl, 1,2-dimethylpropyl, 1,1-dimethylpropyl, hexyl, 4-methylpentyl, 1-methylpentyl, 2-methylpentyl, 3-methylpentyl, 1,1-dimethylbutyl, 2,2-dimethylbutyl, 3,3-dimethylbutyl, 1,2-dimethylbutyl, 1,3-dimethylbutyl, 1,2,2-trimethylpropyl, 1,1,2-trimethylpropyl, heptyl, 5-methylhexyl, 1-methylhexyl, 2,2-dimethylpentyl, 3,3-dimethylpentyl, 4,4-dimethylpentyl, 1,2-dimethylpentyl, 1,3-dimethylpentyl, 1,4-dimethylpentyl, 1,2,3-trimethylbutyl, 1,1,2-trimethylbutyl, 1,1,3-trimethylbutyl, octyl, 6-methylheptyl, 1-methylheptyl, 1,1,3,3-tetramethylbutyl, nonyl, 1-, 2-, 3-, 4-, 5-, 6- or 7-methyloctyl, 1-, 2-, 3-, 4- or 5-ethylheptyl, 1-, 2- or 3-propylhexyl, decyl, 1-, 2-, 3-, 4-, 5-, 6-, 7- and 8-methylnonyl, 1-, 2-, 3-, 4-, 5- or 6-ethyloctyl, 1-, 2-, 3- or 4-propylheptyl, undecyl, 1-, 2-, 3-, 4-, 5-, 6-, 7-, 8- or 9-methyldecyl, 1-, 2-, 3-, 4-, 5-, 6- or 7-ethylnonyl, 1-, 2-, 3-, 4- or 5-propyloctyl, 1-, 2- or 3-butylheptyl, 1-pentylhexyl, dodecyl, 1-, 2-, 3-, 4-, 5-, 6-, 7-, 8-, 9- or 10-methylundecyl, 1-, 2-, 3-, 4-, 5-, 6-, 7- or 8-ethyldecyl, 1-, 2-, 3-, 4-, 5- or 6-propylnonyl, 1-, 2-, 3- or 4-butyloctyl, 1-2-pentylheptyl and isopinocampheyl. Preferred are the alkyl groups methyl, ethyl, propyl, isopropyl, n-butyl, isobutyl, sec-butyl, tert-butyl, amyl, isoamyl, sec-amyl, 1,2-dimethylpropyl, 1,1-dimethylpropyl, hexyl and octyl.

The term “cycloalkyl” denotes a saturated hydrocarbon group comprising between 3 and 16 carbon atoms including a mono- or polycyclic structural moiety. Examples are cyclopropyl, cyclobutyl, cyclopentyl, cyclohexyl, cycloheptyl, cyclooctyl, cyclononyl or cyclodecyl. Preferred are cyclopropyl, cyclopentyl and cyclohexyl.

The term “aryl” denotes an unsaturated hydrocarbon group comprising between 6 and 14 carbon atoms including at least one aromatic ring system like phenyl or naphthyl or any other aromatic ring system.

The term “heteroaryl” denotes a mono- or polycyclic aromatic ring system comprising between 3 and 14 ring atoms, in which at least one of the ring carbon atoms is replaced by a heteroatom like nitrogen, oxygen or sulfur. Examples are pyridyl, pyranyl, thiopyranyl, chinolinyl, isochinolinyl, acridyl, pyridazinyl, pyrimidyl, pyrazinyl, phenazinyl, triazinyl, pyrrolyl, furanyl, thiophenyl, indolyl, isoindolyl, pyrazolyl, imidazolyl, oxazolyl, isoxazolyl, thiazolyl, isothiazolyl and triazolyl.

The term “alkoxy” denotes an —Oalkyl group derived from an aliphatic monoalcohol. The term “aryloxy” denotes an —Oaryl group derived from an aromatic monoalcohol. The term “alkylamino” denotes an alkyl group in which at least one hydrogen atom has been replaced by a —NR₄R₅ group.

In a preferred embodiment the organoborane-amine complex has a molecular weight below 1000 g/mol; in a more preferred embodiment the organoborane-amine complex has a molecular weight below 500 g/mol.

The solution comprises a solvent. The solvent may be a single solvent or a mixture of solvents.

Suitable solvents may be polar solvents such as water, tetrahydrofuran, dioxane, alcohols or non-polar solvents such as hydrocarbons like hexanes, pentanes, heptanes, aromatic hydrocarbons, like toluene, benzene, xylene, ethers like diethylether.

In a preferred embodiment a polar solvent is used, for example, water, an alcohol, ether, lactame, lactone, aldehyde or a ketone. In a most preferred embodiment, an alkanol with 1 to 4 carbon atoms, such as isopropylalcohol (IPA), is used as solvent.

In a preferred embodiment of the present invention the solution comprises from 0.5 to 60% by weight, more preferred 5 to 40% by weight and in particular from 10 to 30% by weight of the organoborane-amine complex.

The solution of step (i) further comprises a polymer.

A polymer is a compound obtained by polymerization of monomers and comprising a least two structural units corresponding to such monomers.

The polymer may be a single polymer or a mixture of polymers. The polymer may be a homopolymer or a copolymer. The copolymer may be a random or a block copolymer.

The polymer may be a polymer obtained by radical polymerization or may be a polycondensate, for example a polyester or a polyamide, or a polyadduct, for example a polyurethane or a polyether.

In a preferred embodiment a polymer is used which is soluble in the solvent of the solution.

Preferably, the polymer has a solubility of at least 1 g, in particular of at least 5 g, more preferred of at least 10 g, most preferred of at least 30 g in 100 g of the solvent at 21° C., 1 bar.

In a particular preferred embodiment, the polymer has a solubility of at least 5 g, more preferred of at least 10 g, most preferred of at least 30 g in 100 g of isopropylalcohol at 21° C., 1 bar.

A preferred polymer is a polyalkylene-oxide, a polyalkylene-glycol, polycaprolactone, a polyvinyllactone, a polyvinyllactame or a mixture thereof.

The polyalkylene-oxide or polyalkylene-glycol may be a hompolymer of a defined alkylene-oxide or a copolymer of a mixture of different alkylene-oxides. In a particular preferred embodiment the alkylene in the polyalkylene-oxide or polyalkylene-glycol is a C1- to C4-alkylene group or a mixture thereof; in particular the alkylene group is ethylene, n-propylene or iso-propylene.

The polyvinyllactone, respectiveley polyvinyllactame, may be a hompolymer of a defined vinyllactone, respectively vinyllactame, or a copolymer comprising different vinyllactones, respectiveley vinyllactames and/or other comonomers which are copolymerizable with vinyllactone, respectively with vinyllactame.

Preferably, the polyvinyllactone is a homopolymer or a copolymer comprising at least 20% by weight, in particular at least 50% by weight of polymerized units derived from a vinyllactone.

Preferably, the polyvinyllactame is a homopolymer or a copolymer comprising at least 20% by weight, in particular at least 50% by weight of polymerized units derived from a vinyllactame.

More preferably, the polyvinyllactame is a homopolymer or a copolymer comprising at least 20% by weight, in particular at least 50% by weight of polymerized units derived from N-vinylpyrrolidone as vinyllactame.

A particular preferred polymer is a polyvinyllactame or a polyalkyleneglycol (PEG).

Most preferred are polyvinylpyrrollidone (PVP) and polyethyleneglycol (PEG).

The polymer may have, for example, a weight average molecular weight (Mw) of 100 to 500.000, in particular of 200 to 400.000 g/mol as determined by gel permeation chromatography.

In a preferred embodiment the solution comprises from 0.1 to 50% by weight, more preferred from 1 to 40% by weight and in particular from 10 to 40% by weight of polymer.

The viscosity of the solution used in (i) is preferably at maximum 10000 mPas, in particular at maximum 5000 mPas; more preferred are solutions having a viscosity of at maximum 1000 mPas, in particular of at maximum 500 mPas. The viscosity of the solution may be very low. However, usually the viscosity will be at least 0.01, respectively at least 0.1 mPas.

The viscosity is the viscosity at 25° C. (atmospheric pressure, 1 bar). The viscosity is measured by a brookfield viscosimeter.

In step (i) the surface of the solid substrate is brought into contact with the solution of the organoborane-amin complex. Contact may, for example, be accomplished by dipping or submersing the substrate, for example a polymer film to be modified, in the solution or, alternatively, by coating the film with the solution using a casting blade, a brush or a spray gun.

Contact is preferably made at 0 to 60° C., in particular at room temperature for a time of from 0.1 to 60 minutes, preferably of from 1 to 10 minutes. Contact is terminated, for example, by removing the polymer film from the solution (in case of dipping and submersing) or by keeping the film in a way that the solution drains off (in case of coating).

To step (ii)

In the second step, the pretreated surface is contacted with a polymerizable compound (shortly referred to as monomer). In this second step the monomer is grafted on the surface and polymerized to give a polymer. The monomer is preferably a monomer that undergoes radical polymerization, in particular radical polymerization via an unsaturated, polymerizable bond, in particular a radically polymerizable carbon-carbon double or triple bond.

The monomer may be one specific monomer or a mixture of monomers. In addition, the monomer or mixture used in step (ii) may comprise a deblocking agent.

A deblocking agent may be required to set free the organoborane part of the organoborane-amine complex. The organoborane acts as grafting and polymerization initiator.

Useful deblocking agents may be any compounds that react with amines. In a preferred embodiment acids that react with the amine part of the organoborane-amine complex are used as deblocking agent. No deblocking agent is needed, for example, if the monomer itself acts as a deblocking agent (e. g. in the case of acrylic acid) or if deblocking can be achieved thermally.

The monomer or the mixture of monomers and optionally deblocking agent is preferably liquid at 25° C. (atmospheric pressure, 1 bar). In case of use or co-use of solid monomers a solvent may be used in order to obtain a liquid mixture.

Again, step (ii) may be accomplished by dipping or submersing the polymer, for example the polymer film, in the liquid mixture or coating the polymer surface with the liquid mixture and allowing the monomer or monomers to graft and polymerize.

As monomers that undergo a radical polymerization reaction, the following classes of monomers are listed:

unsaturated compounds with a structure of formula (2) comprising a polymerizable olefinic double bond

R7R8C═CR9R10 (2),

or with a structure of formula (3) comprising an acetylenic triple bond

R7C≡CR8 (3),

or with a structure of formula (4) comprising a carbonyl group

R7R8C═O (4),

or with a structure of formula (5) comprising a carbon nitrogen double bond

R7R8C═NR9 (5),

wherein R7, R8, R9 and R10 are independently for example hydrogen, alkyl, cycloalkyl, substituted alkyl, aralkyl, alkaryl, alkoxy, aryloxy, alkylamino, aryl or heteroaryl, carbonyl, carboxyl, amide, ester or nitrile groups.

The term “substituted alkyl” denotes an alkyl group in which at least one hydrogen atom is replaced by a halide atom like fluorine, chlorine, bromine or iodine or by a heteroatom, e. g. boron, silicon, nitrogen, phosphorus, oxygen, sulphur or by a protected or unprotected functional group like alkoxy, amino, ammonium, ester, amide, nitrile, carbonyl, carboxyl etc.

The term “aralkyl” denotes an aryl-substituted alkyl group including for example benzyl, 1- or 2-phenylethyl, 1-, 2- or 3-phenylpropyl, mesityl and 2-, 3- or 4-methylbenzyl groups.

The term “alkaryl” denotes an alkyl-substituted aryl group including for example 2, -3- or 4-methylphenyl, 2, -3- or 4-ethylphenyl and 2, -3-, 4-, 5-, 6-, 7- or 8-methyl-1-naphthyl groups.

Preferred monomers have a radically polymerizable carbon-carbon double bond. Such preferred monomers are selected from monomers with an acrylic or methacrylic group, commonly referred to as (meth)acrylics, vinylesters, for example vinyl acetate, vinyl ethers, vinyl lactames, for example N-vinyl pyrrolidone, vinyl aromatics as styrene, vinyl halogenids as vinyl chloride or vinyl fluoride or olefines with one or two carbon-carbon double bonds, such as ethylene, propylene, butadiene or isoprene. In a preferred embodiment of the invention at least 50% by weight, in particular at least 80%, most preferred at least 90% by weight of the monomers in the monomer mixture are selected from the fore standing preferred monomers.

In a more preferred embodiment of the invention the monomer is a monomer with an acrylic or methacrylic group or a mixture of monomers comprising at least 50% by weight, in particular at least 80% by weight and most preferred at least 90% by weight of monomers with an acrylic or methacrylic group.

Preferred monomers with an acrylic or methacrylic group are (meth)acrylic esters, (meth)acrylic acid, (meth)acrylamide, (meth)acrylnitril and glycidyl(meth)acrylate.

In a further preferred embodiment of the invention at least 5%, more preferred at least 10% by weight of the monomers in the monomer mixture are hydrophilic monomers. Hydrophilic monomers shall in particular have a solubility in water of at least 50 parts by weight in 100 parts by weight of water at 21° C., atmospheric pressure. As hydrophilic monomers may be mentioned: acrylic and methacrylic acid, acrylonitrile, vinyl acetate, glycidyl methacrylate (GMA), (meth)acylic esters with an hydroxyl group like 2-hydroxyethylmethacrylate (HEMA), 1-vinyl-2-pyrrolidinone (NVP) or monomers with a salt group like [2-(methacryloyloxy)ethyl] trimethylammonium chloride (QAEMA), diallyldimethylammonium chloride (DADMA),) and N-dodecyl(2-(methacryloyloxy)ethyl)-N,N-dimethylammonium bromide (QAEMA-C12) or mixtures thereof.

In one embodiment of the present invention the radically polymerizable monomer compound is applied in solution. Suitable solvents are e. g. water, alcohols, tetrahydrofuran for polar monomers and hydrocarbons like pentanes, hexanes, heptanes, toluene and benzene or ethers like diethylether and methyl-tert.-butylether for nonpolar monomers. In a preferred embodiment of the present invention the radically polymerizable monomer compound is applied in solution at a concentration in the range of from 1 to 75% (v/v), more preferred in the range of from 2 to 50% (v/v).

In another embodiment of the present invention the radically polymerizable monomer compound is applied as a neat liquid.

According to the invention a deblocking agent has optionally to be employed. A deblocking agent is a compound that is able to split an organoborane-amine complex to liberate the organoborane. Suitable deblocking agents are for example Lewis acids like aluminium trichloride and trifluoroborane, Broensted acids like mineral acids or organic acids, e.g. acrylic acid, methacrylic acid, acetic acid or citric acid, carbon dioxide, aldehydes, ketones, etc. Preferred deblocking agents are acrylic acid and methacrylic acid.

In another embodiment of the present invention an organoborane-amine complex is employed that will sufficiently dissociate at higher temperatures to initiate radical polymerization so that the liberation of the organoborane can be achieved by simple heating of the reaction mixture. In such cases a further deblocking agent is obsolete.

Treatment of the surface with the monomer or monomer mixture comprising optionally a deblocking agent is usually carried out at a temperature of from 0 to 80° C., preferably at room temperature, during a time of from 1 to 100 minutes, preferably of from 10 to 60 minutes.

After the treatments according to the invention any excess polymerized material that is not grafted onto the surface of the piece of polymer can be removed, e.g. by scrubbing the surface with a clean brush under running water or by dissolving any excess polymerized material in a suitable solvent.

With the process of this invention modification of low energy surfaces such as polypropylene with polymers is significantly improved. A complete and homogeneous coverage of the surface with polymer is achieved. Due to better grafting the adhesion of the polymer to the surface is improved. The optical appearance of the modified surface is uniform and homogenous.

The modified surfaces have improved suitability in technical applications, such as coating or printing processes or antibacterial modification of polymer surfaces by antibacterial polymers.

### EXAMPLES

A) Materials used:

Polymer film:

Isotactic polypropylene (PP), 0.05 mm thick

borane-amine complexes used:

tri-sec-butylborane-diaminopropane (TsBB-DAP), formula:

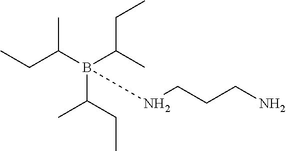

and
tri-n-butylborane-1-methoxypropylamin-3 (TnBB-MOPA)
and
tri-ethylborane-diaminopropane (TEB-DAP) polymers used:
the following Polyvinylpyrrolidone (PVP) trade products have been used:
Luvitec® K90 from BASF having a weight average molecular weight of 1.400.000 g PVP k360 from Sigma-Aldrich which having a weight average molecular weight of 360.000 g Luvitec® K30 from BASF having a weight average molecular weight of 50.000 g

As vinylpyrrolidone copolymer Sokalan® HP 56 which is a vinylpyrrolidone/vinylimidazole copolymer (Mw 70.000) has been used.

As polyethylenglycol PEG k20 from Sigma-Aldrich has been used, which has a (Mw of 20.000).

As polyalkylencopolymer Plurionic® F 127 has been used, which is a triblock copolymer of polyethylenglycol and polypropyleneglycol: PEG-PPG-PEG

Solution of the borane-amine complex and polymer

The solution was prepared by adding the borane-amine complex and the polymer to a solvent; the solvent was isopropylalcohol (IPA), water or dioxolane as listed in table 1.

Monomers and monomer solution

The following monomers have been used:

2-Hydroxyethyl methacrylate (HEMA)
[2-(Methacryloyloxy)ethyl]trimethylammonium chloride (QAEMA)
Metharcylic acid (AAc)

Formulas:

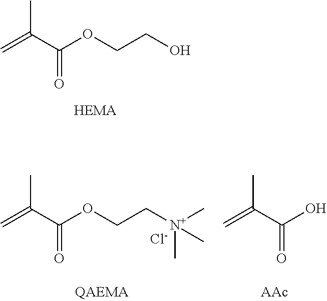

The monomer solution used in the examples consisted of:

19 volume % HEMA
19 volume % QAEMA
2 volume % AAc and
60 volume % H₂O

B) Test procedure for the examples

The procedure was been performed at room temperature (about 25° C.)

A 12 cm×12 cm Polypropylene (PP) film is been fixed in a plastic frame. Dirt and dust has been removed with compressed air. 10 milliliters (ml) of the alkylborane solution (AB) were poured on the PP film. After 5 minutes the solution was removed by hanging the PP film vertically for an interval of 1 min to 30 min.

Then, 10 ml of the above monomer solution were given on the PP film. After 30 minutes the monomer solution was removed. The coated PP film solution was soaked in deionized water for an hour. Thereafter the coated PP film was washed and rubbed film physically with hand to remove excess polymer, which was not bonded to the surface. The coated was kept vertically and dried at room temperature (under air) for 24 hours.

C) Results

The quality of the coatings obtained on the PP films was judged, results of this optical judgement are shown in the table 2:

“none” means that no polymer or only small amounts of polymer were grafted to the surface and hence only small areas, if any, were covered with polymer
“poor” means that the grafted polymer did not cover the surface homogeneously
“good” means that the grafted polymer did cover the surface homogeneously with minor deficiencies, only
“excellent” means that the grafted polymer did cover the surface homogeneously without or nearly without deficiencies

Furthermore the increase of weight of the PP films was determined and the grafting efficiency determined according to the following formula:

Grafting efficiency=weight gained/surface area×100% (mg/cm2)

TABLE 1
solutions of the organoborane-amine complex

| | organoborane-amine | | |
|---|---|---|---|
| | complex, volume % | | polymer, % by |
| | based on total solution | solvent | weight in solution |
| Comparison | TsBB•DAP, 20% | IPA | None |
| example | | | |
| Example 1 | TsBB•DAP, 20% | IPA | PVP (360k), 10% |
| Example 2 | TsBB•DAP, 20% | IPA | PVP (360k), 15% |
| Example 3 | TsBB•DAP, 20% | IPA | PVP (360k), 20% |
| Example 4 | TsBB•DAP, 20% | IPA | PVP (360k), 30% |
| Example 5 | TsBB•DAP, 20% | IPA | PVP (K90), 10% |
| Example 6 | TsBB•DAP, 20% | IPA | PVP K30, 1% |
| Example 7 | TsBB•DAP, 20% | IPA | PVP K30, 2% |
| Example 8 | TsBB•DAP, 20% | IPA | PVP K30, 5% |
| Example 9 | TsBB•DAP, 20% | IPA | PVP K30, 10% |
| Example 10 | TsBB•DAP, 20% | IPA | PVP K30, 15% |
| Example 11 | TsBB•DAP, 20% | IPA | PVP k30, 20% |
| Example 12 | TsBB•DAP, 20% | IPA | PVP (30, 30% |
| Example 13 | TsBB•DAP, 20% | IPA | PVP k30, 35% |
| Example 14 | TsBB•DAP, 20% | IPA | PVP k30, 40% |
| Example 15 | TsBB•DAP, 20% | H2O | PVP K30, 10% |
| Example 16 | TsBB•DAP, 20% | IPA | Sokalan HP 56, 1% |
| Example 17 | TsBB•DAP, 20% | IPA | Sokalan HP 56, 5% |
| Example 18 | TsBB•DAP, 20% | IPA | Sokalan HP 56, 10% |
| Example 19 | TsBB•DAP, 20% | IPA | Sokalan HP 56, 20% |
| Example 20 | TsBB•DAP, 20% | dioxolane | PEG 20k, 0.5% |
| Example 21 | TsBB•DAP, 20% | dioxolane | PEG 20k, 1% |
| Example 22 | TsBB•DAP, 20% | dioxolane | PEG 20k, 5% |
| Example 23 | TsBB•DAP, 20% | dioxolane | PEG 20k, 10% |
| Example 24 | TsBB•DAP, 20% | dioxolane | PEG 20k, 20% |
| Example 25 | TsBB•DAP, 20% | dioxolane | PEG 20k, 30% |
| Example 26 | TsBB•DAP, 20% | dioxolane | PEG 20k, 35% |
| Example 27 | TsBB•DAP, 20% | dioxolane | PEG 20k, 40% |
| Example 28 | TsBB•DAP, 20% | THF | Pluronic F127, 1% |
| Example 29 | TsBB•DAP, 20% | THF | Pluronic F127, 5% |
| Example 30 | TsBB•DAP, 20% | THF | Pluronic F127, 10% |
| Example 31 | TsBB•DAP, 20% | THF | Pluronic F127, 20% |
| | | | (not fully dissolved) |

TABLE 2
characteristics of the modified surface obtained

| | Optical | Grafting efficiency |
|---|---|---|
| | judgement | mg/cm² |
| Comparison | None | 0 |
| example | | |
| Example 1 | good | 1.11 |
| Example 2 | Poor | 0.09 |
| Example 3 | Poor | 0.43 |
| Example 4 | Poor | 0.35 |
| Example 5 | Poor | 0.58 |
| Example 6 | Poor | 0.15 |
| Example 7 | Poor | 0.35 |
| Example 8 | good | 0.75 |
| Example 9 | Excellent | 0.84 |
| Example 10 | Excellent | 1.01 |
| Example 11 | good | 1.11 |
| Example 12 | good | 1.35 |
| Example 13 | good | 1.30 |
| Example 14 | good | 1.21 |
| Example 15 | Poor | 0.18 |
| Example 16 | Poor | 0.15 |
| Example 17 | Excellent | 1.09 |
| Example 18 | Excellent | 0.91 |
| Example 19 | good | 0.33 |
| Example 20 | Poor | 0.31 |
| Example 21 | Excellent | 0.4 |
| Example 22 | Excellent | 1.05 |
| Example 23 | Excellent | 1.17 |
| Example 24 | Excellent | 1.00 |
| Example 25 | Good | 0.83 |
| Example 26 | good | 0.78 |
| Example 27 | poor | 0.57 |
| Example 28 | Excellent | 1.43 |
| Example 29 | Good | 0.65 |
| Example 30 | Good | 0.77 |
| Example 31 | Poor | 0.34 |

1. A process for modifying surface of a solid substrate, the process comprising treating the surface with
(i) a solution comprising an organoborane-amine complex and a polymer and, subsequently,
(ii) a polymerizable compound and, optionally, a deblocking agent.

2. The process of claim 1, wherein the organoborane-amine complex has a structure of formula (I)
R₁R₂R₃B—NR₄R₅R₆ (1),
wherein R₁, R₂ and R₃ are each independently an alkyl group, a cycloalkyl group, an alkyl or cycloalkyl group substituted with a heteroatom, an alkylamino group, an aryl group, a heteroaryl group, an alkoxy group or an aryloxy group, with the proviso that at least one of R₁, R₂ and R₃ is an alkyl or aryl group, and
R₄, R₅ and R₆ are each independently hydrogen, an alkyl group, a cycloalkyl group, a substituted alkyl group, an alkoxy group, an alkylamino group, an aryl group or a heteroaryl group, with the proviso that not more than two of R₄, R₅ and R₆ are simultaneously hydrogen, or
NR₄R₅R₆ is a heterocyclic aliphatic or aromatic amine, optionally comprising at least one heteroatom selected from the group consisting of N, O, S and P.

3. The process of claim 1, wherein the organoborane-amine complex is a trialkylborane-amine complex.

4. The process of claim 1, wherein the polymer is a polyalkylenoxide, a polyalkyleneglycol, a polycaprolactone, a polyvinyllactone, a polyvinyllactame or a mixture thereof.

5. The process of claim 1, wherein the polymer is a polyethyleneglycol or a polyvinylpyrrollidone.

6. The process of claim 1, wherein the solution in (i) comprises 0.1 to 50% by weight of the polymer.

7. The process of claim 1, wherein the polymerizable compound is a radically polymerizable monomer of formula (II)
R₇R₈C═CR₉R₁₀ (II),
or of formula (III)
R₇C≡CR₈ (III),
or of formula (IV)
R₇R₈C═O (IV),
or of formula (V)
R₇R₈C═NR₉ (V),
wherein R₇, R₈, R₉ and R₁₀ are each independently hydrogen, an alkyl group, a cycloalkyl group, a substituted alkyl group, an aralkyl group, an alkaryl group, an alkoxy group, an alkylamino group, an aryl group, a heteroaryl group, a carbonyl group, a carboxyl group, an amide group, a carboxylic ester group or a nitrile group,
or the polymerizable compound is a mixture of radically polymerizable monomers comprising at least one of the radically polyermizable monomers of formulae (II) to (V).

8. The process of claim 1, wherein the polymerizable compound comprises an acrylic or methacrylic group or comprises a mixture of monomers comprising at least 50% by weight of monomers with an acrylic or methacrylic group.

9. The process of claim 1, wherein the deblocking agent is a mineral acid or an organic acid.

10. The process of claim 1, wherein the surface is a polymer surface selected from the group consisting of a polydimethylsiloxane (PDMS), a polyethylene (PE), a polypropylene (PP), a polytetrafluorethylene (PTFE) a polystyrene (PS), a blend thereof and a blend comprising a blend thereof in an total amount of at least 50% by weight.

11. The process of claim 1, wherein the surface is a polypropylene surface.
